(19) United States
(12) Patent Application Publication
(10) Pub. No.: US 2003/0004303 A1
(43) Pub. Date: Jan. 2, 2003

(54) Non-stick coating material having corrosion resistance to a wide range of solvents and mineral acids

(75) Inventors: Mohammed Nazim Khan, Wembley (GB); Naguib Rashid, Wembley (GB)

Correspondence Address: John S. Egbert, Harrison & Egbert, 7th Floor, 412 Main Street, Houston, TX, 77002, US

(73) Assignee: SURFACE ENGINEERING, LTD., Harpenden (GB)

(21) Appl. No.: 10/127,795

(22) Filed: Apr. 23, 2002

(30) Foreign Application Priority Data
Jun. 29, 2001 (GB) 0115949.0

(51) Int. Cl. C08G 73/24

(52) U.S. Cl. 528/401

(57) ABSTRACT

A coating material comprising the following composition: 0.1 to 49 vol % of polyvinylidenefluoride (PVDF), 0.1 to 49 vol % of ethylene chlorotrifluoroethylene copolymer (ECTFE), 0.1 to 49 vol % of fluoroethylenepolypropylene (FEP) and balance substantially polytetrafluoroethylene (PTFE) is synthesized. Sintered coatings of this material are found to be non-stick and offer corrosion protection from a wide range of organic solvents and mineral acids.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a material whose sintered coatings are non-stick and have corrosion resistance to more organic solvents and mineral acids than any other such material.

### BACKGROUND OF THE INVENTION

Other such materials described in the following references are pertinent to the present invention:

1. U.S. Pat. No. 4,655,944

2. U.S. Pat. No. 3,765,932

3.German Pat. WO97/2838OA2

4. French Pat. FR2513906A

5. Japanese Pat. JP8106897A

6. Romania Pat. R085305A.

The coatings using any of the materials given in the above literature, however, do not have corrosion resistance to as many solvents and mineral acids as those using the material given in this invention which can be quite an important requisite in some applications.

### BRIEF SUMMARY OF THE INVENTION

To this end, according to the present invention, there is provided a coating material for sintered coatings consisting of the mixture: 0.1-49 Vol % of PVDF, 0.1-49 Vol % of ECTFE, 0.1-49 Vol % of FEP and balance substantially PTFE, preferably the total contents of the ingredients other than PTFE ranging between 0.5-50 Vol %.

### BRIEF DESCRIPTION OF THE SEVERAL VIEWS OF THE DRAWINGS

Not Applicable.

### DETAILED DESCRIPTION OF THE INVENTION

An explanation will be given hereunder as to the reasons of limitation of the contents of ingredients other than PTFE.

Firstly, the corrosion resistance of the synthesized material is seriously deteriorated if the content of any one of the three ingredients PVDF, ECTFE or FEP is less than 0.1 Vol %. On the other hand, if the content exceeds 49 Vol % it has different undesirable effects on the sintered coatings depending on the ingredient—PVDF gives rise to porosity, ECTFE to brittleness and FEP deteriorates high temperature performance.

In one embodiment of this invention, which is given here by way of example, the material was prepared using the following mixture: 15 vol % of PVDF, 20 vol % of ECTFE, 10 vol % of FEP and the balance PTFE.

This material was sprayed on the substrates using HVLP technique.

The substrates used were 3 mm thick aluminum square pieces of 50 mm sides. These substrates were degreased using hot trichloethylene, abrasive cleaned using 80-120 aluminum oxide grit and heated to 250 deg C. prior to coating. The sprayed substrates were dried and sintered at 400 deg C. for 15 minutes.

One each of these substrates were immersed in six containers containing one of the following solutions: trifluoroacetic acid, dimethylformamide, dimethylesulphoxide, concentrated hydrochloric, nitric and sulphuric acid. After four weeks, the substrates were inspected to check for damage to the coating. It was found that the coating was not attacked by any of the above fluids during this period.

We claim:

1. A coating material comprising the following mixture: 0.1 to 49 vol % of polyvinylidenefluoride (PVDF), 0.1 to 49 vol % of ethylene chlorotrifluoroethylene (ECTFE) copolymer, 0.1 to 49 vol % of fluoroethylenepolypropylene (FEP) and balance substantially polytetrafluoroethylene (PTFE).

2. Sprayed and sintered coatings of the material as described in claim 1.

3. Sprayed and sintered coatings of the material as described in claim 1 applied as a single layer or multilayer coating system.

4. Sintered coatings of the material described in claim 1 applied using dip coating techniques.

5. Sintered coatings of the material described in claim 1 using brushing or trowelling techniques.

6. Sintered claddings of the material described in claim 1 using inert fillers e.g. silicon dioxide or metallic powders.
